(19) United States
(12) Patent Application Publication
(10) Pub. No.: US 2007/0125448 A1
(43) Pub. Date: Jun. 7, 2007

(54) Assembly and method for providing an interlocking angular end joint

(76) Inventor: Richard T. Abbott, Roanoke, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/295,389

(22) Filed: Dec. 6, 2005

(51) Int. Cl. B27C 9/00; B27F 1/00; B27D 1/00; B27G 11/00; B27M 1/08

(52) U.S. Cl. 144/354; 144/1.1; 144/3.1

(57) ABSTRACT

An assembly and method is disclosed for providing an interlocking angular end joint. The interlocking angular end joint is capable of providing a virtually invisible end joint and comprises at least a first board capable of being longitudinally ripped from lumber to a predetermined width, at least a first angle cut at a predetermined angle into at least one end portion relative to the longitudinal length of the first board, and at least a first interlocking member capable of being machined into at least one end portion of the first board.

### BACKGROUND

1. Field of the Invention

The present invention relates generally to the end joining of lumber and, more specifically, to an assembly and method for providing a unique interlocking joint in lumber and moulding.

2. Description of Related Art

High end moulding and millwork have always been a prized architectural feature of fine residences, professional offices, restaurants, and institutional buildings. Unfortunately, most wood species are not abundantly available in wide widths and long lengths to adequately satisfy demand.

Prior-art methods of “jobsite” and factory end joinery provide poor results in high end millwork applications and are generally aesthetically unacceptable. Prior-art methods are plagued with problems, such as readily visible joints, whether painted or stained and very weak joints that open and close with changes of temperature and humidity.

Present and past methods of factory end joinery have focused on saving lumber by joining short waste or scrap boards together to create longer usable marketable lengths. However, the end joints are highly visible and aesthetically unacceptable in premium stain grade woodwork applications. Moreover, even in paint-grade applications, these prior-art end joints “telegraph” through the paint finish and are readily visible to the naked eye. Additionally, present and past methods of “jobsite” end joinery produce open gaps and uneven appearances that are easily visible, unsightly and unacceptable.

The prior-art utilizes angular scarf joints for end joinery. However, these scarf joints are deficient and impractical. The disadvantages are numerous and include at least: (1) inadequate glue surface area created by the scarf joint to provide a strong joint; (2) the scarf joint has no mechanical interlock; (3) the scarf joint is extremely difficult to join reliably with common machining methods and adhesives; and (4) the scarf joint is an unreliable joint due to inherent movement (cupping, curling, and twisting) of wood due to differing grain direction and characteristics in the pieces to be joined, in addition to temperature and moisture changes.

Although many advances have been made in the area of end joinery, many short comings remain.

### SUMMARY OF THE INVENTION

There is a need in the art for an assembly and method for end joining lumber. There is also a need for a virtually invisible end joined moulding. Therefore, it is an object of the present invention to provide an assembly and method for end joining lumber and to provide an end joined moulding.

This object is achieved by providing an interlocking angular end joint capable of providing a virtually invisible end joint. According to the preferred embodiment of the present invention, the interlocking angular end joint comprises at least a first board capable of being longitudinally ripped from lumber to a predetermined width, at least a first angle cut at a predetermined angle into at least one end portion relative to the longitudinal length of the first board, and at least a first interlocking member capable of being machined into at least one end portion of the first board.

It is another object of the present invention to provide an interlocking angular end joint for providing a virtually invisible end joint.

This object is achieved by providing an end joined interlocking angular end joint assembly comprising: at least a first board capable of being longitudinally ripped from lumber to a predetermined width, at least a first angle cut at a predetermined angle into at least one end portion relative to the longitudinal length of the first board, and at least a first interlocking member capable of being machined into at least one end portion of the first board; at least a second board capable of being longitudinally ripped from lumber to a predetermined width, at least a first angle cut at a predetermined angle into at least one end portion relative to the longitudinal length of the second board, and at least a first interlocking member capable of being machined into at least one end portion of the second board; and end joining the first interlocking member of the first board to the first interlocking member of the second board.

It is still another object of the present invention to provide a method for providing an interlocking angular end joint capable of providing a virtually invisible end joint.

This object is achieved by providing a method comprising the steps of ripping at least a first board to a predetermined width, cutting at least a first predetermined angle into at least one end portion relative to the longitudinal length of the first board, and machining at least a first interlocking member into at least one end portion of the first board.

The present invention provides the following advantages: (1) the capabilities to end join relatively short lengths into long lengths wherein the joint becomes virtually invisible after machining a moulding profile; (2) the ability to fabricate lengths of boards beyond the standard available lengths, thereby providing long lengths of moulding without the appearance of an end joint; (3) the ability to make long lengths of boards out of species of lumber for which long lengths are not commercially available; (4) the capability of increasing the strength of the end joined boards to withstand changes in temperature and humidity at the job site or final application; and (5) the ability to provide a very strong end joint with relatively easy machining and assembly that by the nature of its design renders the visibility of the end joint virtually impossible to visually detect.

These and other advantages and features of the present invention will become readily apparent to those skilled in the art upon examination of the subsequent detailed description and accompanying drawings. Accordingly, additional advantages and features of the present invention and the scope thereof are pointed out with particularity in the claims and form a part hereof.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIGS. 1A and 1B illustrate an end joint in accordance with the prior art;

FIG. 2 illustrates an interlocking angular end joint before assembly, in accordance with the preferred embodiment of the present invention;

FIG. 3 illustrates an example interlocking member of FIG. 2 in greater detail, in accordance with the preferred embodiment of the present invention;

FIG. 4 illustrates an interlocking angular end joint after assembly, in accordance with the preferred embodiment of the present invention;

FIG. 5 illustrates a cross sectional view of the end joined interlocking angular end joint of FIG. 4, in accordance with the preferred embodiment of the present invention;

FIG. 6 illustrates the end joined interlocking angular end joint of FIG. 4, shown after assembly; and

FIG. 7 illustrates a high-level flowchart of a process for providing an interlocking angular end joint, in accordance with the preferred embodiment of the present invention.

### DETAILED DESCRIPTION OF THE PREFERRED EMBODIMENT

Reference will now be made to the following detailed description of the preferred and alternate embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

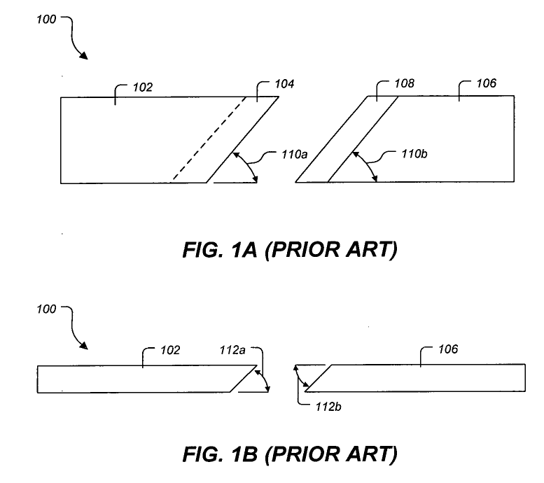

Referring now to FIGS. 1A and 1B in the drawings, an end joint 100 according to the prior art is illustrated. Prior-art end joint 100 includes a first portion 102, a first scarf joint face 104 angularly inclined to the width of first portion 102 at an angle 110a, a second portion 106, a second scarf joint face 108 angularly inclined to the width of second board portion 106 at an angle 110b. First scarf joint face 104 and second scarf joint face 108 further includes a first angular incline 112a and a second angular incline 112b relative to the thickness of the respective portions.

Prior-art end joint 100 typically includes end joining short waste or scrap boards in an effort to create premium length clear boards or mouldings. These short waste or scrap boards are attached in an abutting relationship and produce a visible gap at the end joint. In addition, this visible gap expands and contracts with the change in temperature and produces an unsightly appearance. Furthermore, because the abutted scarf joint is substantially weaker than the waste or scrap boards in an un-altered state, a wooden support member is typically needed in jobsite applications, which is adhesively attached to the back of prior-art end joint 100 to compensate for the less-then-desirable weakness of prior-art end joint 100.

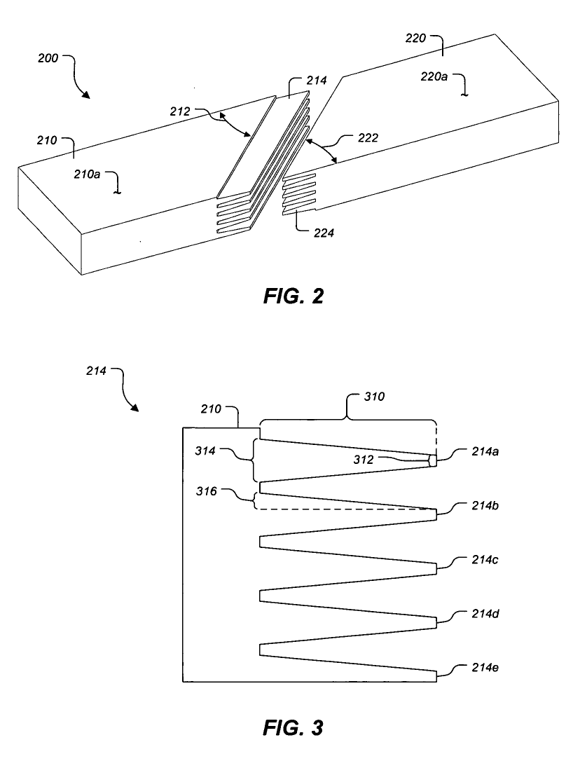

Referring now to FIG. 2 in the drawings, the preferred embodiment of an unassembled interlocking angular end joint 200 according to the present invention is illustrated. Unassembled interlocking angular end joint 200 comprises a first interlocking end portion 210 and a second interlocking end portion 220. First interlocking end portion 210 and second interlocking end portion 220 are capable of being longitudinally ripped from lumber to a predetermined width for the purpose of making interlocking angular end joints of unassembled interlocking angular end joint 200. For simplicity and clarity, only solid lines are shown in first interlocking end portion 210 and second interlocking end portion 220, as is unique to the present invention or necessary for an understanding of the present invention. However, those skilled in the art will recognize that first interlocking end portion 210 and second interlocking end portion 220 are associated with longer longitudinally ripped lumber and not limited to the length or type of cut shown in the figures.

First interlocking end portion 210 comprises top surface 210a and is cut at a predetermined angle 212 relative to the longitudinal length of the ripped lumber. First interlocking end portion 210 further comprises interlocking member 214 capable of being machined into the end surface. Second interlocking end portion 220 comprises top surface 210a and is cut at a predetermined angle 222 relative to the longitudinal length of the ripped lumber. Second interlocking end portion 220 further comprises interlocking member 224 capable of being machined into the end surface.

Angle 212 of first interlocking end portion 210 and angle 222 of second interlocking end portion 220 are capable of being cut at any predetermined angle relative to the longitudinal length of the ripped lumber. In the preferred embodiment of the present invention, angle 212 of first interlocking end portion 210 and angle 222 of second interlocking end portion 220 are complementary angles. As an example and not by way of limitation, angle 212 and maybe angle 222 are identical and are about 45 degrees. In this manner, first interlocking end portion 210 and second interlocking end portion 220 are complementary angles, as shown in FIG. 2, capable of being attached together to form a new longitudinal length of unassembled interlocking angular end joint 200, without departing from the longitudinal plane of the original longitudinally ripped lumber. In an alternate embodiment of the present invention, predetermined angles 212 and 222 may provide any number of complementary angles, such as for example, 10 degrees, 30 degrees, 55 degrees, or any other like complementary angles.

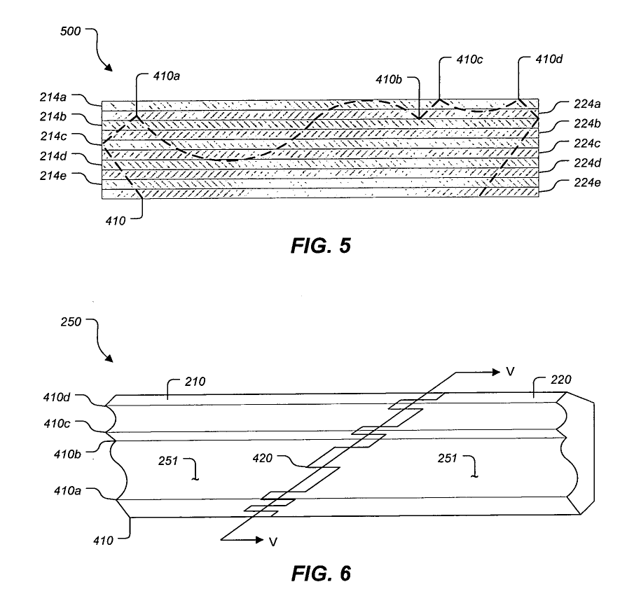

In addition or as an alternative, predetermined angles 212 and 222 may be determined by calculating certain key factors, such as the width of the longitudinally ripped lumber; the interlocking member characteristics such as a finger length 310, a finger tip thickness 312, a finger pitch 314, and a finger slope 316; height and variation or depth associated with moulding profile 410 (see FIG. 5); the type of species of lumber including the grain thereof; and any other key factors. As an example and not by way of limitation, the predetermined angle associated with angle 212 and angle 222 may decrease proportionately with the increase of the depth of moulding profile 410, thereby, discreetly dispersing interlocking members 214 and 224 across the surface area associated with the contoured profile of interlocking end portion 210 and 220, discussed in more detail below.

In the preferred embodiment of the present invention interlocking member 214 and interlocking member 224 comprise one or more interlocking fingers that allow for the mating or interlocking of first interlocking end portion 210 and second interlocking end portion 220 to provide for a virtually invisible end joint associated with unassembled interlocking angular end joint 200. To further explain the interlocking nature of interlocking members 214 and 224, an example is now given. In the following example, interlocking members 214 and 224 comprise fingers machined with high precision and very high tolerances into the end surface of the longitudinally ripped lumber having five fingers protruding from the end surface of both first interlocking end portion 210 and second interlocking end portion 220. On a first end portion of first interlocking end portion 210, a five-finger joint is machined with an offset finger at the top portion of the longitudinally ripped lumber, as shown in more detail in FIG. 3. Likewise, on a second end portion of second interlocking end portion 220, a five-finger joint is machined with an offset finger at the bottom portion of the longitudinally ripped lumber. Thus, the finger joints of interlocking members 214 and 224 provide for the mating or interlocking of first interlocking end portion 210 and second interlocking end portion 220 to provide a virtually invisible end joint.

Although a preferred embodiment of the present invention is shown and described as having a finger joint comprising five fingers associated with interlocking members 214 and 224, the present invention contemplates more, fewer or any number of fingers, according to particular needs. Furthermore, the number of fingers associated with interlocking members 214 and 224 may vary with the thickness of first interlocking end portion 210 or second interlocking end portion 220. In addition or as an alternative, interlocking members 214 and 224 are not limited to the use of only finger joints. For example, interlocking members 214 and 224 may comprise any suitable profile or any suitable type of mating protrusions from the end surface of the longitudinally ripped lumber, such as tongue and groove, grooves and spline, or other like mating protrusions. These protrusions provide for the mating or interlocking of first interlocking end portion 210 and second interlocking end portion 220 to provide a virtually invisible end joint.

Referring now to FIG. 3 in the drawings, the preferred embodiment of an example interlocking member 214, according to the present invention is illustrated. Interlocking member 214 of first interlocking end portion 210 comprises one or more fingers 214a, 214b, 214c, 214d, and 214e. Although interlocking member 214 is shown and described as having a plurality of fingers 214a-214e, the present invention contemplates any suitable number of fingers or any suitable shape or type of protrusions extending from the end surface. Each finger 214a-214e comprises a finger length 310, a finger tip thickness 312, a finger pitch 314, and a finger slope 316.

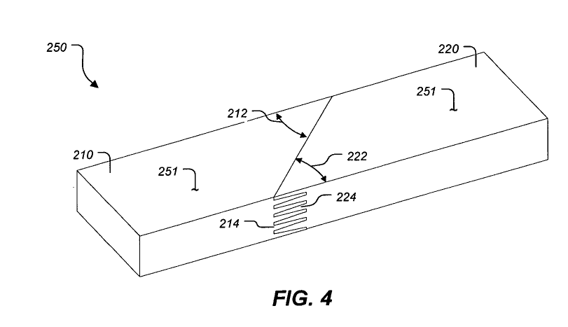

In accordance with the present invention, interlocking member 214 may be adjusted or “tuned” to provide varying tensile strength of end joined interlocking angular end joint 250, (see FIG. 4) by varying the size, shape, or configuration of interlocking member 214. As an example and not by way of limitation, increased tensile strength may be achieved by adjusting finger pitch 314, decreasing finger slope 316, and minimizing finger tip thickness 312. Furthermore, finger length 310 is inversely related to the predetermined angles of angles 212 and 222. For example, by increasing finger length 310; angles 212 and 222 may be decreased to achieve the same dispersement of interlocking members 214 and 224 across the surface area associated with the contoured profile of interlocking angular end joint 210 and 220, as shown and described in more detail in FIG. 6. Likewise, by increasing finger length 310; the height and variation or depth associated with moulding profile 410 of FIG. 6, may be decreased to achieve the same dispersement of interlocking members 214 and 224 across the surface area associated with the contoured profile of unassembled interlocking angular end joint 200.

Referring now to FIG. 4 in the drawings, the preferred embodiment of an assembled end joined interlocking angular end joint 250 according to the present invention is illustrated. End joined interlocking angular end joint 250 comprises first interlocking end portion 210 and second interlocking end portion 220. First interlocking end portion 210 is cut at a predetermined angle 212 relative to the longitudinal length of the ripped lumber. Second interlocking end portion 220 is cut at a predetermined angle 222 relative to the longitudinal length of the ripped lumber. End joined interlocking angular end joint 250 interlocking member 214 of first interlocking end portion 210 interlocked with interlocking member 224 of second interlocking end portion 220. End joined interlocking angular end joint 250 further comprises an assembled top surface 251 dispersed across first interlocking end portion 210 and second interlocking end portion 220.

First interlocking end portion 210 comprises top surface 210a and is cut at a predetermined angle 212 relative to the longitudinal length of the ripped lumber. First interlocking end portion 210 further comprises interlocking member 214 capable of being machined into the end surface. Second interlocking end portion 220 comprises top surface 210a and is cut at a predetermined angle 222 relative to the longitudinal length of the ripped lumber. Second interlocking end portion 220 further comprises interlocking member 224 capable of being machined into the end surface.

Referring now to FIG. 5 in the drawings, the preferred embodiment of a cross sectional view 500 of end joined interlocking angular end joint 250, taken at V-V of FIG. 6, according to the present invention is illustrated. End joined interlocking angular end joint 250 comprises one or more fingers 214a, 214b, 214c, 214d, and 214e of first interlocking end portion 210, one or more fingers 224a, 224b, 224c, 224d, and 224e of second interlocking end portion 220, and a visual representation of an example moulding profile 410. Although end joined interlocking angular end joint 250 is shown and described as having a plurality of fingers 214a-214e and 224a-224e, the present invention contemplates any suitable number of fingers or any suitable interlocking member, according to particular needs. As is shown, the plurality of fingers 214a-214e and 224a-224e of the present invention have been formed with precision machining and tight tolerance thereby creating an almost continuous or homogenous board.

Moulding profile 410 is an end view representing a contour of a moulding profile after machining including various shapes, sizes, and depths dispersed throughout cross sectional view 500. Moulding profiling lines 410a-410d represent vertical peaks and valleys of moulding profile 410, described in more detail in FIG. 5. As an example and not by way of limitation, moulding profile 410 represents crown moulding provided for the installation at an intersection of a wall and ceiling at a final application or job site. Although a crown moulding is shown, any suitable contoured moulding such as; base moulding, chair rail, casing or any other type of component or trim utilized in construction of cabinetry, furniture, boats or any other type of suitable application. Moulding profile 410 provides for the depth of moulding profile 410 to traverse through various layers of fingers 214a-214e of first interlocking end portion 210 and various layers of fingers 224a-224e of second interlocking end portion 220. The inner-dispersement of fingers 214a-214e of first interlocking end portion 210 and the inner-dispersement of fingers 224a-224e of second interlocking end portion 220 provide for interlocking profile 420, as shown in FIG. 6. Although moulding profile 410 is shown and described as having a shape and form of crown moulding, the present invention contemplates any suitable type of component or contoured mouldings, according to particular needs.

It is noted that first interlocking end portion 210 and second interlocking end portion 220 of end joined interlocking angular end joint 250, may be from the same original longitudinally ripped lumber or from any other longitudinally ripped lumber. Furthermore, first interlocking end portion 210 may be associated with one particular species of lumber, while second interlocking end portion 220 may be associated with a different species of lumber. The inner-dispersement of fingers 214a-214e of first interlocking end portion 210 and the inner-dispersement of fingers 224a-224e of second interlocking end portion 220 allow for the dispersement of the grain associated with any species of lumber; thereby creating a intertwined dispersement of grain with respect to one or more species of lumber.

In the preferred embodiment of the present invention, moulding profile 410 is machined into top surface 251 of end joined interlocking angular end joint 250. It is recalled from the above discussion that is not necessary for first interlocking end portion 210 and second interlocking end portion 220 to be adhesively coupled at the time of manufacture, in order for the machining of moulding profile 410 to be performed. Although a preferred embodiment of the present invention is primarily shown and described as having moulding profile 410 associated with the top portion of end joined interlocking angular end joint 250, the present invention contemplates machining the moulding profile 410 or component, on more, fewer or any number of top surface, side surfaces, end surfaces, bottom surfaces, or any other portion associated with end joined interlocking angular end joint 250, moulding profile or component, or unassembled angular end joint 200, according to particular needs.

Referring now to FIG. 6 in the drawings, the preferred embodiment of an end joined interlocking angular end joint 250, according to the present invention is illustrated. End joined interlocking angular end joint 250 comprises first interlocking end portion 210 end joined with second interlocking end portion 220. End joined interlocking angular end joint 250 provides section line V-V for the cross sectional view of FIG. 5. End joined interlocking angular end joint 250 further comprises example moulding profiling lines 410a, 410b, 410c, 410d, and interlocking profile 420 discreetly dispersed across the top portion of end joined interlocking angular end joint 250. Although end joined interlocking angular end joint 250 is shown and described comprising first interlocking end portion 210 end joined to second interlocking end portion 220, the present invention contemplates end joined interlocking angular end joint 250 comprising more, fewer, or any number of interlocking angular end joints, either individually or in combination with other interlocking angular end joints. In particular, the present invention may be used to join many boards together to form longer lengths of boards or components.

Moulding profiling lines 410a-410d represent vertical peaks and valleys of moulding profile 410, also shown in FIG. 5, and may be machined into top surface 251 of end joined interlocking angular end joint 250. As an example and not by way of limitation, moulding profile 410 including moulding profiling lines 410a-410d may represent crown mouldings, chair rails, base boards, or any other suitable type of contoured mouldings or component, according to particular needs. For simplicity and clarity, only a single moulding profile is shown and described, as is unique to the present invention or necessary for an understanding of the present invention. However, those skilled in the art will recognize that these moulding profiles are given by way of example and that the present invention is not limited to the use of these moulding profiles.

In the preferred embodiment of the present invention, first interlocking end portion 210 comprises angle 212 cut at a predetermined angle of about 45 degrees relative to the longitudinal length of first interlocking end portion 210 including an interlocking member 214 machined into the end surface of longitudinally ripped first interlocking end portion 210, as shown in more detail in FIG. 2. Second interlocking end portion 220 likewise, comprises angle 222 cut at a predetermined angle of about 45 degrees relative to the longitudinal length of second interlocking end portion 220 including an interlocking member 224 machined into the end surface of longitudinally ripped second interlocking end portion 220, as shown in more detail in FIG. 2. Interlocking member 214 of first interlocking end portion 210 and interlocking member 224 of second interlocking end portion 220 are placed in contact with each other to provide end joined interlocking angular end joint 250. As described in more detail below, first interlocking end portion 210 and second interlocking end portion 220 may be adhesively coupled together at the time of manufacture, for example, to increase the length of the standard length board provided to a customer. As an example and not by way of limitation, end joined interlocking angular end joint 250 may be provided for higher-end mill work applications such as for banks, law offices, high end retail or other like applications. These applications typically require a more aesthetically pleasing appearance for the moulding profiles and are typically finished with a stain or other type of finishing applications were the prior-art seams or gaps at the end joints become highly visible and unacceptable.

In an alternative embodiment of the present invention, first interlocking end portion 210 and second interlocking end portion 220 are not adhesively coupled together at the time of manufacture, but instead provided to the customer as standard length boards, or for any suitable length of boards. As an example and not by way of limitation, the standard lengths provided to the customer may be eight-foot lengths, ten-foot lengths, twelve-foot lengths, sixteen-foot lengths, or other convenient lengths. In this manner, the assembly and adhesion process is performed subsequent to the manufacturing of first interlocking end portion 210 and second end portion 220, at the customer location or job site. In addition or as an alternative, first interlocking end portion 210 comprises a first angle 212 cut at a predetermined angle of about 45 degrees relative to a first end portion of the longitudinal length of first interlocking end portion 210 and a second angle 212 cut at a predetermined angle of about 45 degrees relative to a second end portion of the longitudinal length of first interlocking end portion 210. First interlocking end portion 210 further comprises a first interlocking member 214 machined into a first end portion of the longitudinally ripped first interlocking end portion 210 and a second interlocking member 214 machined into a second end portion of the longitudinally ripped first interlocking end portion 210. Second interlocking end portion 220 likewise, comprises a first angle 222 cut at a predetermined angle of about 45 degrees relative to a first end portion of the longitudinal length of second interlocking end portion 220 and a second angle 222 cut at a predetermined angle of about 45 degrees relative to a second end portion of the longitudinal length of second interlocking end portion 220. Second interlocking end portion 220 further comprises a first interlocking member 214 machined into a first end portion of the longitudinally ripped second interlocking end portion 220 and a second interlocking member 224 machined into a second end portion of the longitudinally ripped second interlocking end portion 220.

In this manner, the customer receives standard or otherwise specified lengths of boards that may be utilized for various end user applications. For example, the end user may be a customer who purchases these unassembled interlocking angular end joints at a retail home center that carries only standard length moulding profiles. If the customer is installing, for example, crown moulding on the intersection of a wall and ceiling of a desired length greater then the standard length supplied by the retail home center, the customer may purchase two unassembled interlocking angular end joints to achieve the desired length of the application. This provides the customer with a finished product giving the visual appearance of an interlocking angular end joint comprising a plurality of standard length moulding profiles.

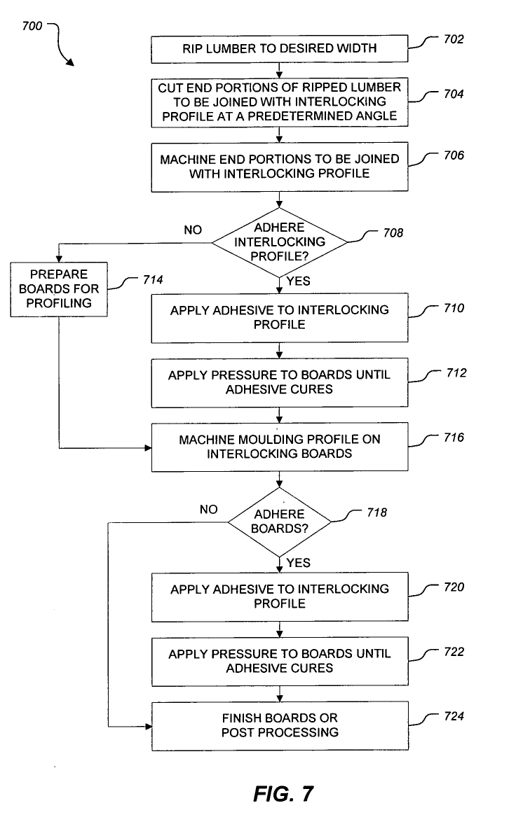

Referring now to FIG. 7 in the drawings, the preferred embodiment of a high-level flowchart 700 of a process for providing an interlocking angular end joint, according to the present invention is illustrated. Flowchart 700 starts at step 702 with the longitudinally ripping of lumber to a predetermined width for the purpose of making interlocking angular end joints of interlocking angular end joint 200. Next, in step 704, the longitudinally ripped lumber is cut at a predetermined angle relative to the longitudinal length of the ripped lumber. In addition or as an alternative, predetermined angles 212 and 222 may be based on the calculation of key factors such as the width of the longitudinally ripped lumber, the interlocking member characteristics such as finger length 310, fingertip thickness 312, finger pitch 314, and finger slope 316, the moulding profile including the height and variation or depth associated with the profile, the type of species of lumber including the grain thereof, and any other like key factors.

The process continues with step 706, with the machining of interlocking members 214 and 224 into the end surface of at least one interlocking angular end joint 200. It is recalled from the above discussion that interlocking members 214 and 224 may be for example, a finger joint comprising at least one finger protruding from the end portion of the longitudinally ripped lumber. For simplicity and clarity only so much of the machining processes as is unique to the present invention or necessary for an understanding of the present invention is shown and described. Furthermore, those skilled in the art will recognize various ways to machine interlocking members 214 and 224; for example, the end surface of interlocking angular end joint 200 may be applied to a shaping machine comprising a finger joint bit to machine interlocking members 214 and 224.

The process continues with inquiry step 708, in which a determination is made as to whether interlocking members 214 and 224 of one or more interlocking angular end joints 200 will be adhered. It is recalled from the above discussion of FIG. 6, that first interlocking end portion 210 comprising at least a first interlocking member 214 may be adhesively coupled with at least one of a second interlocking end portion 220 comprising at least a first interlocking member 224 of interlocking angular end joint 200, at the time of manufacture. Thus, if interlocking members 214 and 224 of interlocking angular end joint 200 are to be adhered to at least one or more interlocking angular end joints 210 or 220, the process continues with step 710. On the other hand, it is also recalled from the above discussion of FIG. 6, that first interlocking end portion 210 comprising at least a first interlocking member 214 may not be adhesively coupled together with another second interlocking end portion 220 comprising at least a first interlocking member 224 of interlocking angular end joint 200, at the time of manufacture, but instead provided to the customer as standard length boards for bulk lumber sales. Thus, if interlocking members 214 and 224 of interlocking angular end joint 200 are not to be adhered to at least one or more interlocking angular end joints 210 or 220, the process continues at step 714.

Next, in step 710, an adhesive is applied to interlocking member 214 of first interlocking end portion 210 and interlocking member 224 of second interlocking end portion 220 of end joined interlocking angular end joint 250. Then, in step 712, pressure in the form of vertical and/or horizontal force is applied to end joined interlocking angular end joint 250 to ensure a proper attachment of interlocking member 214 and interlocking member 224, until at least the adhesive cures. For simplicity and clarity only so much of the adhesion processes as is unique to the present invention or necessary for an understanding of the present invention is shown and described. Furthermore, those skilled in the art will recognize various ways to cure the adhesive; for example, high frequency heating may be applied to interlocking members 214 and 224, to provide for a more rapid cure of the adhesive.

It is recalled from inquiry step 708 that if interlocking members 214 and 224 of interlocking angular end joint 200 are not adhered to at least one or more interlocking angular end joints, the process continues at step 714. Next, in step 714, non-adhered interlocking angular end joint 200 is prepared for machining of moulding profile 410. As an example and not by way of limitation, first interlocking end portion 210, i.e. a non-adhered interlocking board, may be secured to another interlocking board in a non-adhesive process, for example, second interlocking end portion 220, or a “dummy” interlocking board to prevent damage to first interlocking end portion 210 during the machining of moulding profile 410.

The process then continues with step 716; in essence, step 716 provides for the profiling of moulding of both adhered interlocking members and non-adhered interlocking members. Step 716 provides for the machining of moulding profile 410 into a virtually invisible end joined interlocking angular end joint 250 until all portions associated with end joined interlocking angular end joint 250 are profiled according to moulding profile 410. It is recalled from the above discussion of FIG. 5, that although the preferred embodiment of the present invention is primarily shown and described as having moulding profile 410 associated with the top portion of end joined interlocking angular end joint 250, the present invention contemplates machining moulding profile 410 on more, fewer or any number of side surfaces, end surfaces, bottom surface, or any other surface associated with end joined interlocking angular end joint 250, according to particular needs.

Next, in inquiry step 718, a determination is made as to whether interlocking members 214 and 224 of one or more interlocking angular end joints 200 will be adhered. Step 718 is similar to the above discussion of step 708; with the exception that moulding profile 410 is already machined into interlocking angular end joint 200 or end joined interlocking angular end joint 250. In this step, the manufacturer may determine whether to adhere one or more of interlocking members 214 and 224, subsequent to the machining of moulding profile 410. Thus, if interlocking members 214 and 224 of interlocking angular end joint 200 are to be adhered to at least one or more interlocking end portions, the process continues with step 720. On the other hand, if interlocking members 214 and 224 of end joined interlocking angular end joint 250 have already been adhered, or are not to be adhered to at least one or more interlocking end portions, the process continues at step 724. Next, in step 720, an adhesive is applied to interlocking member 214 and interlocking member 224 of one or more interlocking angular end joints 200, as described above in step 710. Then in step 722, pressure in the form of vertical and/or horizontal force is applied to end joined interlocking angular end joint 250 to ensure a proper attachment of interlocking members 214 and 224, as described above in step 712.

The process ends in step 724, in which a determination is made as to the appropriate post process required for end joined interlocking angular end joint 250. The manufacturer may sand, stain, varnish or otherwise finish unassembled interlocking angular end joint 200, according to particular needs. The process ends in step 724, where the last post process is to ship the finished interlocking angular end joint 200 or end joined interlocking angular end joint 250 to the customer, either in custom lengths or in standard length boards for bulk lumber sales.

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

1. An interlocking angular end joint comprising:
a first board;
a first angle cut at a predetermined angle into at least one end portion of the first board; and
a first interlocking member capable of being machined into the at least one end portion of the first angle of the first board.

2. The interlocking angular end joint according to claim 1, further comprising:
a second board;
a second angle cut at a predetermined angle into at least one end portion of the second board; and
a first interlocking member capable of being machined into the at least one end portion of the first angle of the second board.

3. The interlocking angular end joint according to claim 2, further comprising:
the capability of interlocking the first interlocking member of the first board to the first interlocking member of the second board; and
the capability of adhesively coupling the first interlocking member of the first board to the first interlocking member of the second board.

4. The interlocking angular end joint according to claim 1, wherein the first interlocking member comprises:
one or more fingers associated with the first board;
a finger length associated with the one or more fingers;
a finger tip thickness associated with the one or more fingers;
a finger pitch associated with the one or more fingers; and
a finger slope associated with the one or more fingers.

5. The interlocking angular end joint according to claim 4, wherein a moulding profile is capable of being machined into at least one of:
a top portion of the first board;
a side portion of the first board; and
a bottom portion of the first board.

6. The interlocking angular end joint according to claim 5, wherein the moulding profile comprises the contour of at least one of:
a crown moulding;
a chair rail; and
a base board.

7. The interlocking angular end joint according to claim 5, wherein the first angle is determined by calculating key factors comprising at least one of:
a width of the interlocking angular end joint;
a finger length of the first interlocking member;
a finger tip thickness of the first interlocking member;
a finger pitch of the first interlocking member;
a finger slope of the first interlocking member; and
a height and a variation of depth associated with the moulding profile.

8. An end joined interlocking angular end joint assembly comprising:
a first board comprising:
a first angle cut at a predetermined angle into at least one end portion of the first board; and
a first interlocking member capable of being machined into the at least one end portion of the first angle of the first board;
a second board comprising:
a second angle cut at a predetermined angle into at least one end portion of the second board; and
a first interlocking member capable of being machined into the at least one end portion of the first angle of the second board; and
end joining the first interlocking member of the first board to the first interlocking member of the second board.

9. The end joined interlocking angular end joint assembly according to claim 8, further comprising:
adhering the interlocking member of the first board to the first interlocking member of the second board.

10. The end joined interlocking angular end joint assembly according to claim 8, further comprising:
a second angle cut at a predetermined angle into the end portion of the first board;
a second interlocking member capable of being machined into the end portion of the second angle of the first board;
a second angle cut at a predetermined angle into at least one end portion of the second board; and
a second interlocking member capable of being machined into the at least one end portion of the second angle of the second board.

11. The end joined interlocking angular end joint assembly according to claim 8, wherein at least the first interlocking member comprises:
one or more fingers associated with the first board;
a finger length associated with the one or more fingers;
a finger tip thickness associated with the one or more fingers;
a finger pitch associated with the one or more fingers; and
a finger slope associated with the one or more fingers.

12. The end joined interlocking angular end joint assembly according to claim 11, wherein a moulding profile is capable of being machined into at least one of:
a top portion of the end joined interlocking angular end joint assembly;
a side portion of the end joined interlocking angular end joint assembly; and
a bottom portion of the end joined interlocking angular end joint assembly.

13. The end joined interlocking angular end joint assembly according to claim 12, wherein the moulding profile comprises the contour of at least one of:
a crown moulding;
a chair rail; and
a base board.

14. The end joined interlocking angular end joint assembly according to claim 12, wherein the first angle is determined by calculating key factors comprising at least one of:
a width of a interlocking angular end joint;
a finger length of the first interlocking member;
a finger tip thickness of the first interlocking member;
a finger pitch of the first interlocking member;
a finger slope of the first interlocking member; and
a height and a variation of depth associated with the moulding profile.

15. A method for providing an interlocking angular end joint, the method comprising the steps of:
ripping a first board to a predetermined width;
cutting a first predetermined angle into at least one end portion of the first board relative to the longitudinal length of the first board; and
machining a first interlocking member into the at least one end portion of the first angle of the first board.

16. The method according to claim 15, further comprising the steps of:
ripping a second board to a predetermined width;
cutting a first predetermined angle into at least one end portion of the second board relative to the longitudinal length of the second board; and
machining a first interlocking member into the at least one end portion of the first angle of the second board.

17. The method according to claim 16, further comprising the steps of:
end joining the first interlocking member of the first board to the first interlocking member of the second board; and
adhering the first interlocking member of the first board to the first interlocking member of the second board.

18. The method according to claim 15, wherein machining the first interlocking member further comprises the step of:
machining one or more fingers into the at least one end portion of the first angle of the first board, the one or more fingers comprising:
a finger length associated with the one or more fingers;
a finger tip thickness associated with the one or more fingers;
a finger pitch associated with the one or more fingers; and
a finger slope associated with the one or more fingers.

19. The method according to claim 18, further comprising the steps of at least one of:
machining a moulding profile into a top portion of a first board,
machining a moulding profile into a side portion of a first board, and
machining a moulding profile into a bottom portion of a first board.

20. The method according to claim 19, wherein the first predetermined angle is determined by calculating key factors comprising the steps of at least one of:
determining a width of the interlocking angular end joint;
determining a finger length of the first interlocking member;
determining a finger tip thickness of the first interlocking member;
determining a finger pitch of the first interlocking member;
determining a finger slope of the first interlocking member; and
determining a height and a variation of depth associated with the moulding profile.
